(19) United States
(12) Patent Application Publication
(10) Pub. No.: US 2019/0258965 A1
(43) Pub. Date: Aug. 22, 2019

(54) SUPERVISED LEARNING SYSTEM

(71) Applicant: Cisco Technology, Inc., San Jose, CA (US)

(72) Inventors: Lukas Machlica, Prague (CZ); Ivan Nikolaev, Prague (CZ); Jan Brabec, Rakovnik (CZ)

(21) Appl. No.: 15/901,915

(22) Filed: Feb. 22, 2018

(51) Int. Cl. G06N 99/00; H04L 9/32

(52) U.S. Cl. CPC G06N 99/005; H04L 9/32

(57) ABSTRACT

In one embodiment, a method including accessing a trained classifier, the trained classifier trained based at least on a first data item and including both decision determination information of the first data item and decision explanation information of at least one second data item, the second data item being distinct from the first data item; receiving an item for classification; using the trained classifier to classify the item for classification; and providing item decision information regarding a reason for classifying the item for classification, the item decision information being based on at least a part of the decision explanation information. Other embodiments are also described.

### TECHNICAL FIELD

The present disclosure generally relates to supervised learning systems, and more specifically to systems for providing explanations of classification decisions made using supervised learning systems.

### BACKGROUND

Machine learning solutions are known in which supervised learning is used to train a blackbox classifier. One non-limiting example of such a classifier is a decision tree; other examples of black-box classifiers are known in the art. For simplicity of description, and without limiting the generality of the foregoing, the example of a decision tree is often used throughout the present specification.

Once a decision tree has been trained, items for classification are entered into the decision tree and classified. Some solutions for explaining why a decision tree chose to classify a given item in a given way are known in the art.

### BRIEF DESCRIPTION OF THE DRAWINGS

The present disclosure will be understood and appreciated more fully from the following detailed description, taken in conjunction with the drawings in which:

FIG. 1 is a simplified schematic illustration of a decision tree constructed and operative in accordance with an embodiment of the present disclosure;

FIG. 2 is a simplified schematic illustration of another decision tree constructed and operative in accordance with another embodiment of the present disclosure;

FIG. 3 illustrates pseudo code which provides a particularly detailed non-limiting example of how the decision tree of FIG. 2 may be built;

FIG. 4 is a simplified block diagram illustration of an exemplary device suitable for implementing various ones of the systems, methods or processes described herein;

FIG. 5 is a simplified flowchart illustration of a method for training a classifier; and

FIG. 6 is a simplified flowchart illustration of a method for applying a trained classifier.

### OVERVIEW

A system includes a processor and a memory to store data used by the processor. The processor is operative to access at least one first data item used to train a classifier; access at least one second data item, the second data item not being used to train the classifier; produce a trained classifier based on training using the at least one first data item; store in the trained classifier, as decision determining information, information of the at least one first data item; and also store in the trained classifier, in association with the decision determining information, decision explanation information of the at least one second data item.

A system includes a processor; and a memory to store data used by the processor. The processor is operative to: access a trained classifier, the trained classifier trained based at least on a first data item and including both decision determination information of the first data item and decision explanation information of at least one second data item, the second data item being distinct from the first data item; receive an item for classification; use the trained classifier to classify the item for classification; and provide item decision information regarding a reason for classifying the item for classification, the item decision information being based on at least a part of the decision explanation information.

A method includes accessing at least one first data item used to train a classifier; accessing at least one second data item, the second data item not being used to train the classifier; producing a trained classifier based on training using the at least one first data item; storing in the trained classifier, as decision determining information, information of the at least one first data item; and also storing in the trained classifier, in association with the decision determining information, decision explanation information of the at least one second data item.

A method includes accessing a trained classifier, the trained classifier trained based at least on a first data item and including both decision determination information of the first data item and decision explanation information of at least one second data item, the second data item being distinct from the first data item; receiving an item for classification; using the trained classifier to classify the item for classification; and providing item decision information regarding a reason for classifying the item for classification, the item decision information being based on at least a part of the decision explanation information.

A computer-readable storage medium includes stored therein data representing software executable by a computer, the software including instructions including: instructions for accessing at least one first data item used to train a classifier; instructions for accessing at least one second data item, the second data item not being used to train the classifier; instructions for producing a trained classifier based on training using the at least one first data item; instructions for storing in the trained classifier, as decision determining information, information of the at least one first data item; and instructions for also storing in the trained classifier, in association with the decision determining information, decision explanation information of the at least one second data item.

A computer-readable storage medium includes stored therein data representing software executable by a computer, the software including instructions including: instructions for accessing a trained classifier, the trained classifier trained based at least on a first data item and including both decision determination information of the first data item and decision explanation information of at least one second data item, the second data item being distinct from the first data item; instructions for receiving an item for classification; instructions for using the trained classifier to classify the item for classification; and instructions for providing item decision information regarding a reason for classifying the item for classification, the item decision information being based on at least a part of the decision explanation information.

### DESCRIPTION OF EXAMPLE EMBODIMENTS

As explained above, machine learning solutions are known in which supervised learning is used to train a blackbox classifier such as, by way of non-limiting example, a decision tree. Other non-limiting examples of such classifiers include logistic regression models, neural networks, and random forests. Once a classifier (such as a decision tree) has been trained, items for classification are entered into the trained classifier and are classified. Some solutions for explaining why a classifier chose to classify a given item in a given way are known in the art and are discussed below.

For simplicity of description, and without limiting the generality of the foregoing, the example of a decision tree is often used throughout the present specification. In the case of a decision tree, when items for classification are presented for classification a series of decisions is made at various branches (nodes) of the tree, based on various criteria, until a leaf node of the tree is reached and the item has been classified. Therefore, it is straightforward to provide an explanation of the ultimate classification decision by outputting/stating (“playing back”) the decisions made at various branch nodes of the tree. Examples of more general ways of providing an explanation for the decision of a classifier, applicable more widely than a case of a decision tree, are known to persons skilled in the art.

A different problem is presented in some cases. One example of such a case is when the items to be classified comprise encrypted traffic, such as encrypted network traffic. In such a case, the information used to make a decision at various branches of a decision tree may be obscure and difficult to verify as correct. In particular, and without limiting the generality of the foregoing, such information may be obscure and difficult for a human being to understand, such that if a human operator were to query the reason for a given classification (whether directly or via a log file or the like) and the decisions made at various branches were played back (whether directly or into a log file or the like), the “reasoning” behind the classification would still be quite unclear to the human operator. Certain embodiments presented herein are designed to address these problems, and to provide better explanations of classification decisions.

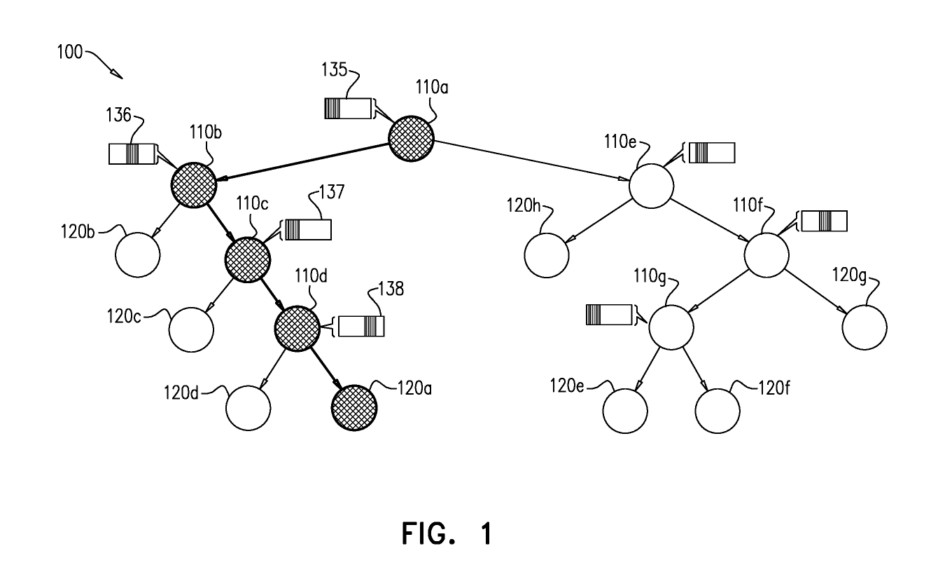

Reference is now made to FIG. 1, which is a simplified schematic illustration of a decision tree constructed and operative in accordance with an embodiment of the present disclosure. In FIG. 1 a decision tree 100 is shown. The decision tree 100 comprises a plurality, generally a multiplicity, of branch nodes 110 which include branch nodes 110a-110g, and also comprises leaf nodes 120 which include leaf nodes 120a-120h. For simplicity of depiction, a limited number of branch nodes 110 and leaf nodes 120 is depicted in FIG. 1, it being appreciated that in practice a larger number of such nodes may be comprised in the decision tree 100.

The decision tree 100 of FIG. 1 is generally created by a training process. Each depicted branch node 110 represents a decision regarding an item to be classified, based on associated decision information; for example, in FIG. 1 decision determination information 135 is associated with root node 110a of the decision tree 100. In a training process, known items conceptually enter the tree at the root node 110a and are classified by passing through branch nodes 110 until reaching a leaf node 120. If, for example, for a plurality of known items which are either known to be “good” or known to be “bad”, the decision tree 100 can be determined to be successful or unsuccessful according to how well it succeeds in classifying known-good items as good, and known-bad items as bad.

One non-limiting example of a training process suitable for training the decision tree 100 of FIG. 1 is referred to herein as the “regular Random Forest algorithm”. In the regular Random Forest algorithm, a decision tree such as the decision tree 100 of FIG. 1 is trained automatically using a training set comprising exemplar data. At each branch node 110 a split function is defined in such a way as to optimize the split function so that the data is split as best as possible; “best” being defined in a particular way given the particular task to be performed when using the decision tree. For a tree like the decision tree 100 of FIG. 1, “best” could mean that the child nodes of each branch node 110 are as “pure” as possible, so that each child node would in practice receive as many items which are similar to each other as possible, and as few different items as possible. In addition, the training process is generally constrained to produce a decision tree having, for example, one or more of the following: a maximum number of levels; a determined level of “purity” as described above; and no less than a minimum number of items at each leaf node 120.

Once a decision tree such as decision tree 100 of FIG. 1 has been trained, the decision tree 100 is used to classify “unknown” items (continuing the above example, items for which it is not known whether the items are “good” or “bad”). When an item to be classified (also termed herein an “item for classification”) is received, the item for classification (not shown) conceptually enters the tree at the root node 110a. At the root node 110a decision determination information 135 is used to begin classifying the item for classification. In the example of FIG. 1, based on the decision determination information 135 associated with the root node 110a, the item for classification is passed on to node 110b.

Similarly, the item for classification continues to pass through the decision tree at nodes 110c and 110d. At nodes 110a, 110b, 110c, and 110d a test based on associated determination information 135, 136, 137, and 138, respectively, is used to send the item for classification on to a further node; for simplicity of depiction, only a portion of the determination information has been assigned reference numerals in FIG. 1. For example, at node 110b the item for classification is examined based on the determination information 136 associated with node 110b. For example, the determination information might comprise “if size of item for classification exceeds 1056 bytes proceed to node 110c; else proceed to node 120b”. In the particular example shown in FIG. 1, the item for classification is sent on to node 110c, and not to node 120b, because the size of the item for classification exceeds 1056 bytes.

When the item for classification reaches a leaf node 120, the item for classification has been classified. In the example of FIG. 1, the item reaches leaf node 120a and is classified accordingly; that is, the item for classification is classified according to a classification associated with leaf node 120a. For example, if leaf node 120a is associated with the classification “suspected dangerous malware”, then the item for classification may be classified at leaf node 120a as “suspected dangerous malware”. For ease of depiction, the nodes 110a, 110b, 110c, 110d, and 120a which were “visited” by the item for classification are shown with hashing.

If it is desired to provide an explanation of the “reasoning” behind the classification (whether to a human operator, to a log file, or otherwise), the “reasoning” may comprise the decisions made at nodes 110a, 110b, 110c, and 110d, based in each such case on associated determination information 135, 136, 137, and 138 respectively. In the particular example discussed, the “reasoning” will comprise “size of item exceeds 1056 bytes”, per the decision made at node 122 based on the determination information 136 associated with node 122; the “reasoning” will also comprise information per the decisions made at nodes 110a, 110c, and 110d, based on determination information 135, 137, and 138, respectively.

As described above, there may be cases in which the “reasoning” provided by a decision tree such as the decision tree 100 of FIG. 1 is inadequate. One example of such a case is when the items to be classified comprise encrypted traffic, such as, by way of non-limiting example, encrypted network traffic. In such a case, the information used to make a decision at each such branch of a decision tree may be obscure and difficult for a human being to understand, such that if a human operator were to query the reason for a given classification and, in order to provide such a reason, the decisions made at each such branch were played back, the “reasoning” behind the classification would still be quite unclear to the human operator. For example, as described above the “reasoning” may comprise “size of item exceeds 1056 bytes”; it may not be apparent to a human operator why “size of item exceeds 1056 bytes” is part of the reasoning for classifying an item as suspected dangerous malware.

It will be appreciated that one of the challenges in providing “reasoning” which would be clear to a human operator is that, during use of a decision tree such as the decision tree 100 to classify items, the determination information 135, 136, 137, and 138 relates to characteristics of an item for classification which were used to train the decision tree 100 and which are readily known at the time of classification of the item for classification. For example, during a training phase of the decision tree 100, as described above, an item for classification may have been determined to be suspected dangerous malware by being executed in a controlled environment, such as a sandbox, and it may have been determined that many items which are suspected dangerous malware have a size of item exceeding 1056 bytes, thus leading to the determination information 136. However, in the training phase of the decision tree 100 the decision tree 100 was trained based on information (such as the determination information 135, 136, 137, and 138) which would be readily known at the later time of classification of an item; an item to be classified is not executed in a sandbox when it is to be classified, and hence the results of execution in a sandbox, which execution may have taken place at the time of training the decision tree 100, are not included in the determination information 135, 136, 137, and 138.

Data sources from a sandboxing environment can be used to show Indicators of Compromise (IOCs) associated with the classified behavior. Examples of such IOCs, based on behavior during execution in a sandbox, include by way of non-limiting example: accessing the Windows registry or certain sensitive portions thereof; or modifying or attempting to modify an executable file; executing portions of memory in a way which is deemed suspicious; creating or attempting to create a DLL file; and so forth.

It is appreciated that execution in a sandbox, as described above, is provided as one particular example of a mechanism for determining one or more characteristics known at the time of training but not readily known regarding an item for classification, or difficult to determine regarding an item for classification, when an item for classification is to be classified; for example, execution in a sandbox would be expected to be difficult and/or time-consuming to carry out when an item for classification is to be classified. Other examples of such characteristics which are difficult to determine when an item for classification is to be classified include, but are not limited to, information from proxy logs captured on the training data or features that are easy to understand but are expensive to calculate in a “live” environment when the trained decision tree 100 is used to classify an item to be classified. Characteristics which would be expected to be difficult and/or time-consuming to carry out when an item for classification is to be classified are also termed herein “inappropriate to use in real time”.

Proxy logs created when a proxy is used to connect to a site can, for example, provide information about Uniform Resource Locators (URLs), user agent/s, referrer/s and similar information. In general, log entries in proxy logs reveal information about the client making the request, date/time of the request, and the name of an object or objects requested. It is appreciated that the log entry information listed is a non-limiting example of log entry information that might be found in a proxy log.

Examples of expensive features as referred to above may include, by way of non-limiting example:
information extracted from external data feeds, such as a query to VirusTotal (a product/site available via the World Wide Web which includes information aggregated from malware vendors; accessing VirusTotal requires an application programming interface (API) key, would require significant resource use, and would thus be inappropriate to use in real time);
information extracted from a whois database; and
features calculated from large amounts of data during the training; such features might include additional status information, a number of users who visited a particular domain, etc.; such information changes quickly and takes a long time to determine, and thus would be inappropriate to use in real time.

Thus, in a very particular example, it could be possible and might be desirable for “reasoning” to not simply be “this particular behavior is malicious”, or “this particular behavior is malicious because of excessive up-packets in the 83rd percentile of the distribution in combination with irregular access timings”. The “reasoning” could specifically point out the malicious behavior and a list of associated informative IOCs such as modifying the registry, sending a number of emails which exceeds a particular limit, and accessing domains that have a lot of hits on VirusTotal, as explained above.

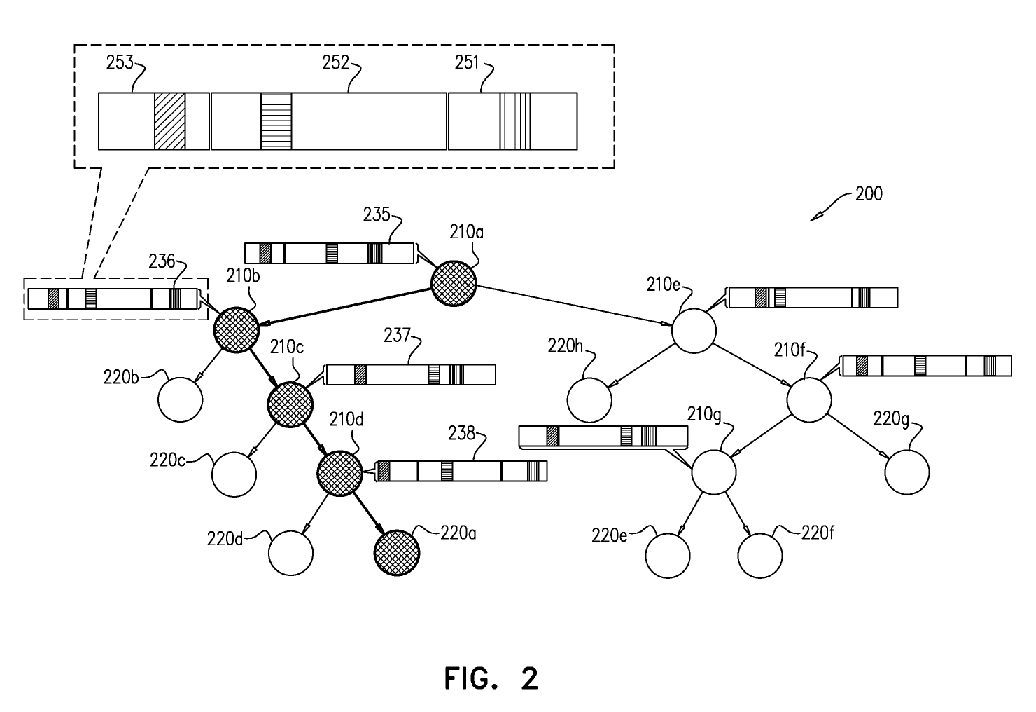

Reference is now made to FIG. 2, which is a simplified schematic illustration of another decision tree constructed and operative in accordance with another embodiment of the present disclosure. In FIG. 2 a decision tree 200 is shown. The decision tree 200 comprises a plurality, generally a multiplicity, of branch nodes 210 which include branch nodes 210a-210g, and also comprises leaf nodes 220 which include leaf nodes 220a-220h. For simplicity of depiction, a limited number of branch nodes 210 and leaf nodes 220 is depicted in FIG. 2, it being appreciated that in practice a larger number of such nodes may be comprised in the decision tree 200.

The decision tree 200 may be created by a training process which differs from the training process described above for the decision tree 100 of FIG. 1. In particular, as a result of the training process (a particularly detailed non-limiting example of which is described below) determination information comprised in the decision tree 200 includes, as described in more detail above and below, both information readily available at a time when an item for classification is to be classified (that information being used for training the decision tree 200), and also other information which is available when training the decision tree 200 but which is not readily available at the time when an item for classification is to be classified by the already-trained decision tree 200.

Once a decision tree such as the decision tree 200 of FIG. 2 has been trained, the decision tree 200 is used to classify “unknown” items. When an item to be classified (“item for classification”) is received, the item for classification (not shown) conceptually enters the tree at the root node 210a. At the root node 210a decision determination information 235 is used to begin classifying the item for classification. In the example of FIG. 2, based on the decision determination information 235 associated with the root node 210a, the item for classification is passed on to node 210b.

Similarly, the item for classification continues to pass through the decision tree at nodes 210c and 210d. At nodes 210a, 210b, 210c, and 210d a test based on associated determination information 235, 236, 237, and 238, respectively, is used to send the item for classification on to a further node. For example, at node 210b the item for classification is examined based on the determination information 236 associated with node 210b.

In the decision tree 200, determination information such as the determination information 236 may comprise, as explained above, both information available at a time when an item for classification is to be classified, and other information which is available at a time of training but which other information is not readily available at the time when an item for classification is to be classified. For example, the determination information 236 may comprise available determination information 251, which is actually used for classifying an item to be classified, as well as non-available determination information 252 and 253, which are information that was available at a time of training but relate to one or more characteristics typical of items for classification, but which are not readily known/not readily available regarding particular item for classification at the time when the item for classification is to be classified.

For example, the determination information might comprise available determination information 251 indicating “if size of item for classification exceeds 1056 bytes proceed to node 210c; else proceed to node 220b”. In the particular example shown in FIG. 2, the item for classification is sent on to node 210c, and not to node 220b, because the size of the item for classification exceeds 1056 bytes.

When the item for classification reaches a leaf node 220, the item for classification has been classified. In the example of FIG. 1, the item reaches leaf node 220a and is classified accordingly; that is, the item for classification is classified according to a classification associated with leaf node 220a. For example, if leaf node 220a is associated with the classification “suspected dangerous malware”, then the item for classification may be classified at leaf node 220a as “suspected dangerous malware”. For ease of depiction, the nodes 210a, 210b, 210c, 210d, and 220a which were “visited” by the item for classification are shown with hashing.

If it is desired to provide an explanation of the “reasoning” behind the classification (whether to a human operator, to a log file, or otherwise), the “reasoning” may comprise the decisions made at nodes 210a, 210b, 210c, and 210d, based at the respective nodes on associated determination information 235, 236, 237, and 238 respectively. In the particular example discussed, the “reasoning” will comprise “size of item exceeds 1056 bytes”, per the decision made at node 210b based on the determination information 236 associated with node 210b; the “reasoning” will also comprise information per the decisions made at nodes 210a, 210c, and 210d, based on determination information 235, 236, 237, and 238, respectively. In addition, the “reasoning” may comprise non-available determination information 252 and/or 253, which, as indicated above, are information that was available at a time of training but relate to one or more characteristics which are not readily known/not readily available at the time when the item for classification is to be classified. For example, the non-available determination information 252 may comprise “execution in a controlled environment suggests malware”.

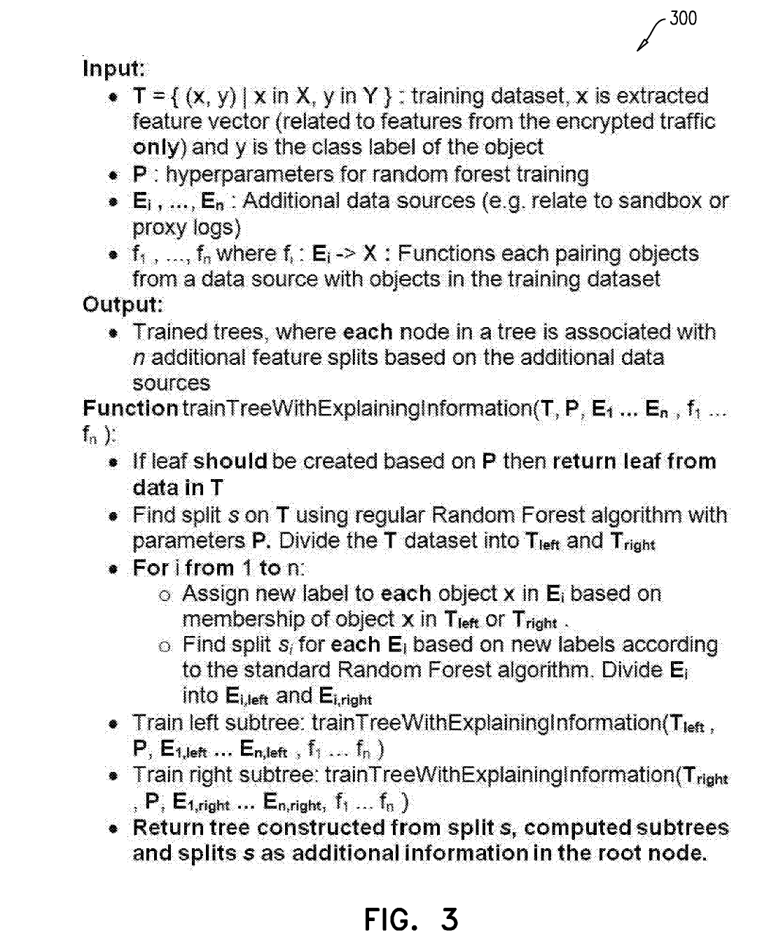

Reference is now made to FIG. 3, which illustrates pseudo code 300 which provides a particularly detailed non-limiting example of how the decision tree of FIG. 2 may be built. In the pseudo code of FIG. 3:

a) pairing between data sources is implicit in the input functions f₁, . . . , fₙ. In one example described above, where a sandbox is used, network behavior of a particular piece of code is known based on behavior of the piece of code when executed in a sandbox. In another example, where VirusTotal is used, information extracted from VirusTotal (based, for example, on a particular domain) may be used.

b) the reference to “regular Random Forest algorithm”, may, in one non-limiting example, refer to the regular Random Forest algorithm described above.

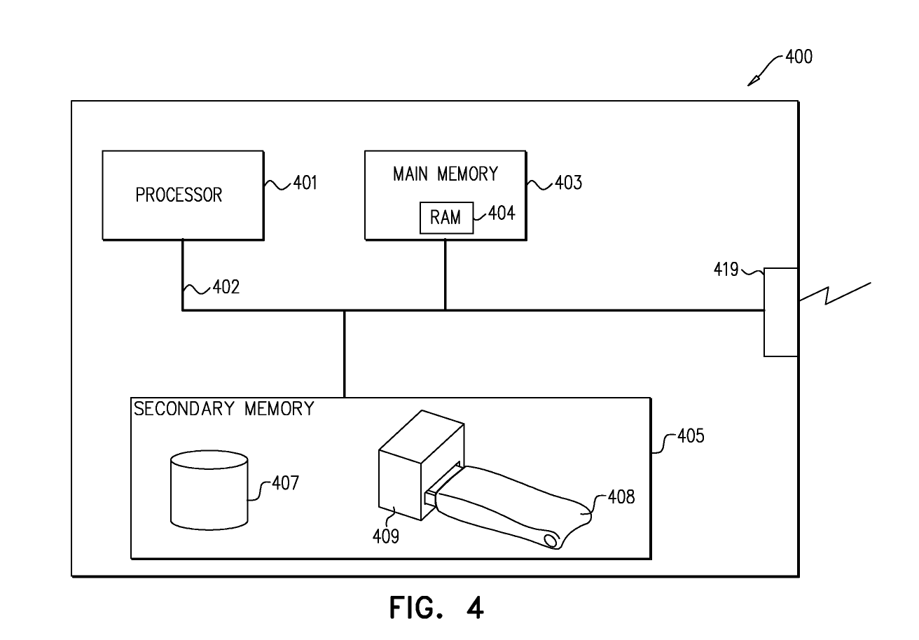

Reference is now made to FIG. 4, which is a simplified block diagram illustration of an exemplary device 400 suitable for implementing various ones of the systems, methods or processes described above.

The exemplary device 400 comprises one or more processors, such as processor 401, providing an execution platform for executing machine readable instructions such as software. One of the processors, such as by way of non-limiting example the illustrated processor 401, may be a special purpose processor operative to perform the methods for building a tree and/or the methods for classifying items described herein above. Processor 401 comprises dedicated hardware logic circuits, in the form of an application-specific integrated circuit (ASIC), field programmable gate array (FPGA), or full-custom integrated circuit, or a combination of such devices. Alternatively or additionally, some or all of the functions of the processor 401 may be carried out by a programmable processor microprocessor or digital signal processor (DSP), under the control of suitable software. This software may be downloaded to the processor in electronic form, over a network, for example. Alternatively or additionally, the software may be stored on tangible storage media, such as optical, magnetic, or electronic memory media.

Commands and data from the processor 401 are communicated over a communication bus 402. The system 400 also includes a main memory 403, such as a Random Access Memory (RAM) 404, where machine readable instructions may reside during runtime, and further includes a secondary memory 405. The secondary memory 405 includes, for example, a hard disk drive 407 and/or a removable storage drive 408, representing a floppy diskette drive, a magnetic tape drive, a compact disk drive, a flash drive, etc., or a nonvolatile memory where a copy of the machine readable instructions or software may be stored. The secondary memory 405 may also include ROM (read only memory), EPROM (erasable, programmable ROM), EEPROM (electrically erasable, programmable ROM). In addition to software, data representing the decision tree 200 of Fig. discussed above, without limiting the generality of the foregoing, or other similar data, may be stored in the main memory 403 and/or the secondary memory 405. The removable storage drive 408 is read from and/or written to by a removable storage control unit 409 in a well-known manner.

A network interface 419 is provided for communicating with other systems and devices via a network. The network interface 419 typically includes a wireless interface for communicating with wireless devices in the wireless community. A wired network interface (e.g. an Ethernet interface) may be present as well. The exemplary device 400 may also comprise other interfaces, including, but not limited to Bluetooth, and HDMI. It is appreciated that logic and/or software may, in addition to what is described above and below, be stored other than in the main memory 403 and/or the secondary memory 405; without limiting the generality of the foregoing, logic and/or software may be stored in a cloud and/or on a network and may be accessed through the network interface 419 and executed by the processor 401.

It will be apparent to one of ordinary skill in the art that one or more of the components of the exemplary device 400 may not be included and/or other components may be added as is known in the art. The exemplary device 400 shown in FIG. 4 is provided as an example of a possible platform that may be used; other types of platforms may be used as is known in the art. One or more of the steps described above and/or below may be implemented as instructions embedded on a computer readable medium and executed on the exemplary device 400. The steps may be embodied by a computer program, which may exist in a variety of forms both active and inactive. For example, they may exist as software program(s) comprised of program instructions in source code, object code, executable code or other formats for performing some of the steps. Any of the above may be embodied on a computer readable medium, which include storage devices and signals, in compressed or uncompressed form. Examples of suitable computer readable storage devices include conventional computer system RANI (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running a computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated above may be performed by any electronic device capable of executing the above-described functions.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

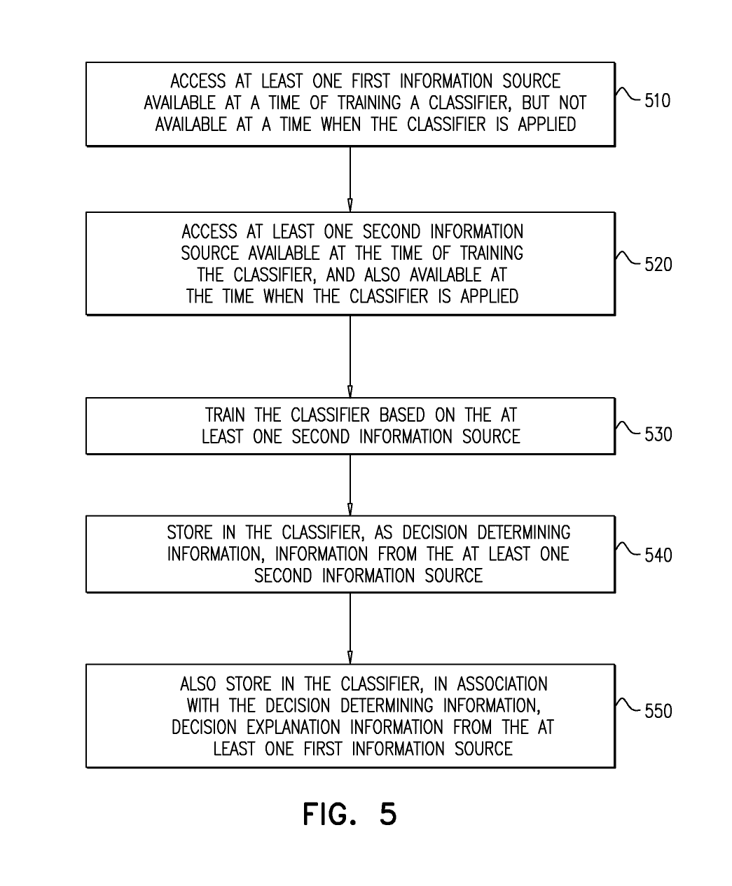

Reference is now made to FIG. 5, which is a simplified flowchart illustration of an exemplary method for training a classifier. In the method of FIG. 5, at least one first information source available when a classifier is trained, but not readily available at a time when the classifier is applied, is accessed at step 510. At step 520, at least one second information source is accessed, the second information source being available at the time of training the classifier and also being readily available when the classifier is applied. The classifier is trained based on the at least one second information source at step 530, and decision determining information from the at least one second information source is stored in the classifier at step 540. In addition to the decision determining information, decision explanation information from the at least one first information source is stored in the classifier at step 550.

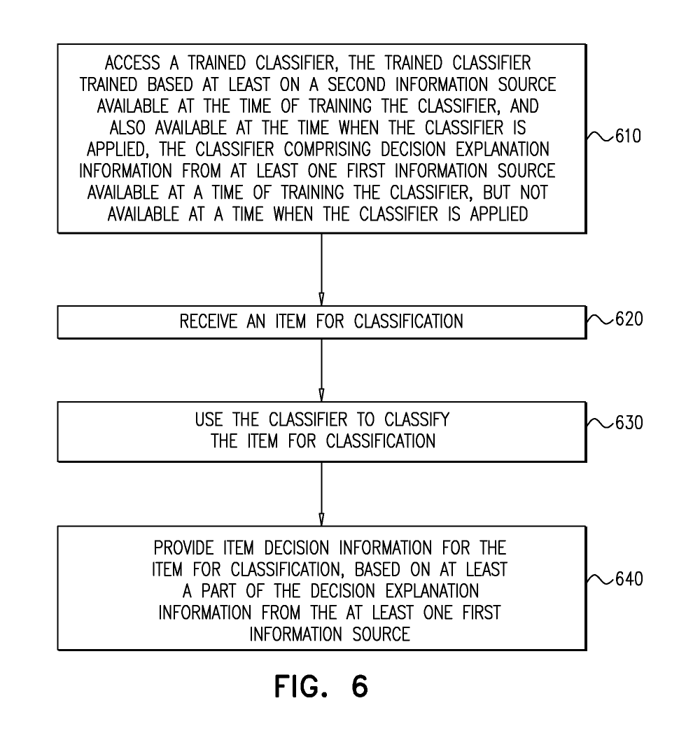

Reference is now made to FIG. 6, which is a simplified flowchart illustration of a method for applying a trained classifier. In step 610, a trained classifier is accessed. The trained classifier is a classifier trained based at least on a second information source available when the classifier is trained, and also readily available when the classifier is applied. The trained classifier also includes decision explanation information from at least one first information source which is available when the classifier is trained, but which is not readily available when the classifier is applied. An item to be classified is received at step 620, and the classifier is used to classify the item at step 630. At step 640, item decision information for the item is provided; the item decision information is based on at least a part of the decision information from the at least one first information source.

The methods of FIGS. 5 and 6 are believed to be self-explanatory with reference to the above discussion, and in particular with reference to the above discussion of FIGS. 2 and 3.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. A system comprising a processor; and a memory to store data used by the processor, wherein the processor is operative to:
access at least one first data item used to train a classifier;
access at least one second data item, the second data item not being used to train the classifier;
produce a trained classifier based on training using the at least one first data item;
store in the trained classifier, as decision determining information, information of the at least one first data item; and
also store in the trained classifier, in association with the decision determining information, decision explanation information of the at least one second data item.

2. The system according to claim 1 and wherein the processor is also operative to:
use the trained classifier to classify an item;
provide information from the trained classifier regarding a reason for classifying the item, the information including the decision explanation information.

3. The system according to claim 2 and wherein the item comprises an event.

4. The system according to claim 3 and wherein the event comprises receiving an encrypted data item.

5. The system according to claim 4 and wherein the encrypted data item comprises an executable data item, and the reason comprises behavior of the encrypted data item when executed.

6. The system according to claim 4 and wherein the encrypted data item comprises an executable data item, and the reason comprises behavior of the encrypted data item when executed in a sandbox.

7. The system according to claim 4 and wherein the behavior comprises behavior classified as suspicious behavior.

8. The system according to claim 1 and wherein the classifier comprises a decision tree.

9. The system according to claim 8 and wherein the decision tree comprises a plurality of decision trees.

10. A system comprising a processor; and a memory to store data used by the processor, wherein the processor is operative to:
access a trained classifier, the trained classifier trained based at least on a first data item and comprising both decision determination information of the first data item and decision explanation information of at least one second data item, the second data item being distinct from the first data item;
receive an item for classification;
use the trained classifier to classify the item for classification; and
provide item decision information regarding a reason for classifying the item for classification, the item decision information being based on at least a part of the decision explanation information.

11. The system according to claim 10 and wherein the item for classification comprises an event.

12. The system according to claim 11 and wherein the event comprises receiving an encrypted data item.

13. The system according to claim 12 and wherein the encrypted data item comprises an executable data item, and the reason comprises behavior of the encrypted data item when executed.

14. The system according to claim 12 and wherein the encrypted data item comprises an executable data item, and the reason comprises behavior of the encrypted data item when executed in a sandbox.

15. The system according to claim 12 and wherein the behavior comprises behavior classified as suspicious behavior.

16. The system according to claim 10 and wherein the classifier comprises a decision tree.

17. The system according to claim 16 and wherein the decision tree comprises a plurality of decision trees.

18. A method comprising:
accessing at least one first data item used to train a classifier;
accessing at least one second data item, the second data item not being used to train the classifier;
producing a trained classifier based on training using the at least one first data item;
storing in the trained classifier, as decision determining information, information of the at least one first data item; and
also storing in the trained classifier, in association with the decision determining information, decision explanation information of the at least one second data item.

19. The method according to claim 18 and wherein the classifier comprises a decision tree.

20. A method comprising:
accessing a trained classifier, the trained classifier trained based at least on a first data item and comprising both decision determination information of the first data item and decision explanation information of at least one second data item, the second data item being distinct from the first data item;
receiving an item for classification;
using the trained classifier to classify the item for classification; and
providing item decision information regarding a reason for classifying the item for classification, the item decision information being based on at least a part of the decision explanation information.

21. The method according to claim 20 and wherein the trained classifier comprises a decision tree.
